(19) United States
(12) Patent Application Publication
(10) Pub. No.: US 2004/0267576 A1
(43) Pub. Date: Dec. 30, 2004

(54) Method for referencing data records which include therapeutic advice items

(76) Inventors: Klaus Abraham-Fuchs, Erlangen (DE); Eva Rumpel, Erlangen (DE)

Correspondence Address: HARNESS, DICKEY & PIERCE, P.L.C., P.O.BOX 8910, RESTON, VA, 20195, US

(21) Appl. No.: 10/849,252

(22) Filed: May 20, 2004

(30) Foreign Application Priority Data
May 20, 2003 (DE) 10322687.7

(51) Int. Cl. G06F 17/60; G06F 7/00; G06F 17/00

(52) U.S. Cl. 705/3; 707/100

(57) ABSTRACT

A method is for referencing data records which include therapeutic advice items, in which each data record associated with a therapeutic advice item includes a unique order feature which is likewise stored together with a therapeutic information item based on the therapeutic advice item. Further, a therapeutic advice item being updated prompts all of the therapeutic information items to be searched for the order feature of the updated therapeutic advice item. A report, indicating the change in the underlying therapeutic advice item is then output for each therapeutic information item found in the process.

The present application hereby claims priority under 35 U.S.C. §119 on German patent application number DE 103 22 687.7 filed May 20, 2003, the entire contents of which are hereby incorporated herein by reference.

### FIELD OF THE INVENTION

The invention generally relates to a method for referencing therapeutic advice items, particularly data records which include “medical guidelines”. Such data records are themselves referred to as a therapeutic advice item for short below. The data records may include both data items, that is to say therapeutic advice items, and executable codes, that is to say software fragments, e.g. in the form of expert rules.

### BACKGROUND OF THE INVENTION

In recent years, “medical guidelines” (medical practice guidelines or clinical practice guidelines), guidelines for short, have become increasingly significant. Guidelines are diagnostic and/or therapeutic recommendations for action and decisions (subsequently referred to as therapeutic advice items in general and in summary) to the doctor which have been drawn up in a broad consensus by superordinate and generally recognized committees in the medical profession.

Naturally, such therapeutic advice items need to be continually brought into line with the latest level of knowledge and are thus subject to continual, if normally long or medium term, change. Typically, therapeutic advice items are revised and brought into line at intervals of a few years. A doctor who treats patients, when making diagnostic and therapeutic decisions, on the basis of such established therapeutic advice items is now confronted by the challenge of obtaining information about any change in the therapeutic advice items in real time and of taking into account the most recent situation in each case.

Since therapeutic processes, in particular, can extend over months and years, it is an even greater challenge to the doctor to have an overview, at the time at which a therapeutic advice item changes, of which of his patients are currently undergoing treatment in line with the obsolete version of the therapeutic advice item, and for which of these patients the new version of the therapeutic advice item requires that the therapy be changed.

To solve these problems, no automatically executable methods have been disclosed in the prior art to date to the best of the applicant's knowledge. In addition, the broad use of therapeutic advice items, particularly in the form of guidelines, is just starting to appear in medicine.

### SUMMARY OF THE INVENTION

An embodiment of the invention is therefore based on an object of specifying a method for using such centrally created and provided therapeutic advice items, such as the aforementioned guidelines, in as simple and safe a manner as possible. This object includes two aspects. First, it includes the need for unique referenceability of data records associated with a plurality of therapeutic advice items for the purpose of safely finding a data record associated with a single therapeutic advice item in line with prescribed criteria. The other aspect of this object relates to the simplest and most safe use possible of the therapeutic advice items using the data records in medical institutions, and, in this context, particularly to the integration of changing or updated therapeutic advice items in the course of therapy.

An embodiment of the invention achieves the first aspect of this object by use of a method for referencing a data record. The method of this embodiment includes therapeutic advice items. A first database includes a number of data records associated with a plurality of therapeutic advice items, where each data record associated with a therapeutic advice item is assigned a unique order feature. The order feature is assigned a version identifier and possibly a use advice item.

The order feature associated with each therapeutic advice item in the data record in question allows the respective therapeutic advice item to be uniquely referenced. In this case, the order feature is advantageously assigned, in addition to the referencing code, an information item relating to a version identifier. The version identifier can be used to identify that therapeutic advice item which, depending on the preset, represents the most current or a past or previous version.

In addition or alternatively, the order feature can be designed such that it is possible to identify all therapeutic advice items which relate to the same medical problems. In this regard, the order feature, which may be in the form of a character string, for example, that is to say in the form of a text string with a prescribed format, including, after a particular position in the text string, a code, particularly an alphanumeric code, uniquely identifying the medical problem, as a use advice item. By requesting the use advice item, it is possible to ascertain all therapeutic advice items relating to the same medical problem.

If the use advice item itself is also formed on the basis of a prescribed format, it is advantageously possible to divide medical problems into case groups and sub-case groups etc. This makes even more specifically oriented identification of therapeutic advice items for particular medical problems possible. On the other hand, by way of example, it is also possible, if just particular case groups are being sought, that is to say the rest of the use advice item is disregarded, to identify parallelisms in therapeutic advice items for medical problems which are basically different.

An embodiment of the invention achieves the second aspect of the aforementioned object by a method for referencing a data record which includes therapeutic advice items. A first database includes a number of therapeutic advice items, with every therapeutic advice item being assigned a unique order feature. The second database includes a number of data records which include therapeutic information items relating to an individual therapy.

In this case, the data records associated with therapeutic information items include data items, that is to say therapeutic information items, for example about patients and/or diagnostic and/or therapeutic devices/methods and/or other resources which are used, and which even may be required for a therapy. The data records including therapeutic information items themselves are referred to as a therapeutic information item for short below. For the method, provision is expediently made for the order feature of that therapeutic advice item on which the therapy is based to be stored for single or a plurality of therapeutic information items associated with a data record.

In addition, any change or update for a therapeutic advice item preferably first involves the changed or updated therapeutic advice item being stored as a new therapeutic advice item in the first database together with a unique order feature. The second database is then searched for therapeutic information items with the order feature of the corresponding old therapeutic advice item on which the new therapeutic advice item is based. Finally, a report is generated for each obsolete order feature which is found in the second database and for this underlying obsolete therapeutic advice item.

Optionally, a report may be generated for every new therapeutic advice item regardless of the previous use of the obsolete, replaced or complemented therapeutic advice item, so that the users of the first and/or second database are informed about medical progress at all times. This information item may be oriented to users in particular disciplines on the basis of an appropriately structured order feature.

An embodiment of the invention is based on the insight that the use of modern information and communication technology is currently being greatly expanded in the health service in parallel and independently of the introduction of guidelines in medicine. The use of electronic data processing in hospitals, (e.g. HIS=Hospital Information System, RIS—Radiology Information System, PACS=Picture Archive & Communication System, LIS=Laboratory Information System) and in doctor's practices (practice management software, electronic patient records) is becoming more and more usual. A subsequent development step is generally expected to network this software and these databases across the institutions in the health service (clinics, doctor's practices, therapeutic practices etc.). This provides the option of a “networked health service”, at first at national or regional level and later globally. This development provides the basis for use of the two aspects of embodiments of the invention.

With regard to the first aspect of the aforementioned object, one advantageous refinement of an embodiment of the inventive solution involves the order feature being assigned a release attribute which indicates the release of the respective therapeutic advice item. This actually allows therapeutic advice items which are still on trial, for example, to be set in the first database. Interested doctors or therapists can obtain information about progress in particular fields of treatment at any time. That is to say that a therapeutic advice item is released by superordinate committees, such as by a specialist medical association, and said release is independent of the institutions which use the advice, such as clinics.

If, in addition or alternatively to the release attribute, an activation attribute is produced and linked to the therapeutic advice item, it is possible to protect single therapeutic advice items, that is to say obsolete or outdated therapeutic advice items, from further use. To this end, the associated activation attribute for the therapeutic advice item in question is activated or deactivated. The activation attribute is thus activated for current and released therapeutic advice items.

For obsolete or outdated therapeutic advice items, the activation attribute in question is deactivated. That is to say that, if the activation attribute for an obsolete or outdated therapeutic advice item has been reset, then the deactivated activation attribute can be used to suppress reuse of the obsolete therapeutic advice item for a current treatment or therapy. Hence, if such therapeutic advice items with a deactivated activation attribute also remain in the first database, then the history of the development of the single therapeutic advice item is maintained at all times. The activation attribute performs the function of indicating that patients with a particular clinical picture are preferably treated in line with the therapeutic advice item if there are no conflicting case-specific medical concerns.

If the order feature is additionally or alternatively assigned a use attribute which indicates the current use of the therapeutic advice item, it is possible to identify at all times which therapeutic advice items are currently being used in the course of treating a patient. This is useful for local copies of the first database, for example. The local copy, which is kept on a server in a clinic, for example, needs to contain only those therapeutic advice items which are actually used in the practice. In addition, the use attribute is important in order to be able to offer, for therapeutic advice items which are used, a direct way of providing information about therapeutic advice items which complement, correct or update the therapeutic advice item which is being used.

Preferably, the use attribute and/or the activation attribute is complemented by a date or is linked thereto. This usefully complements the history of the development of the therapeutic advice item (activation attribute) and the history of the use of the therapeutic advice item (use attribute).

With regard to the first aspect of the aforementioned object, one advantageous refinement of an embodiment of the inventive solution involves the first database or a further third database assigning each therapeutic advice item a use attribute which indicates the use of this therapeutic advice item. The function of the use attribute has already been explained.

The use attribute is expediently assigned to the first database. This allows the operator of the first database to identify which therapeutic advice items are being used. However, the use attribute may also include information items regarding who (i.e. which doctor or therapist, in which institution, e.g. clinic) is using the respective therapeutic advice item and where it is being used (town, district, region, country etc.).

If the operator of the first database is no longer able to handle a use attribute—which thus essentially contains an arbitrary level of detail—to an appropriate degree, the use attribute may also be stored in a further database. If the use attribute is stored in a third database, safe and simple decoupling is achieved between therapeutic advice items and therapeutic information items, on the one hand, and better manageability of the use attribute is achieved for a selected group of users, e.g. for particular connected medical institutions, particular doctors and therapists in a medical institution.

If the use attribute is stored, alternatively or in addition, in the second database, that is to say, by way of example, in a database which is kept in a medical institution, such as a clinic, then this institution and every user of the second database has a patient-related overview of the therapeutic advice items being used at all times.

The statements made above also apply in a similar manner to the release attribute and/or activation attribute (already explained further above), which is advantageously assigned to each therapeutic advice item, either directly or via its order feature, in the first database or in a further third database, and is stored there.

Advantageously, the activation attribute of the new therapeutic advice item, which is based on the corresponding old therapeutic advice item, is activated, with this involving the activation attribute of the corresponding obsolete therapeutic advice item being deactivated at the same time. A deactivated activation attribute thus indicates whether the therapeutic advice item is obsolete and that, instead of the obsolete therapeutic advice item, a new therapeutic advice item has been transferred to the first database, or the obsolete therapeutic advice item has been deleted or its activation attribute has been deactivated.

On the basis of the use attribute which has been set, therapeutic information items which are based on the obsolete therapeutic advice item are advantageously still identified in the second database. Thus, the obsolete therapeutic advice item can remain in the first database until therapies which are based on this therapeutic advice item have been completed.

The order feature preferably has an associated descriptor for the therapeutic advice item and a version number. This allows particularly convenient identification of the therapeutic advice item. In addition, the version number ensures that the development of individual therapeutic advice items is logged.

The therapeutic advice item is preferably a medical guideline. If it is not yet possible to formulate a therapeutic advice item in the form of a guideline, then the therapeutic advice item is suitable precursors to such guidelines, that is to say, by way of example, literature references referring to research reports and the like. The therapeutic information item is preferably an (electronic) patient record.

In line with another advantageous development of an embodiment of the invention, provision is made for a knowledge base to store a number of rules. Each rule relates to references to a transition from an obsolete therapeutic advice item to a new therapeutic advice item. Further, a selection algorithm is used to select one of the rules on the basis of the obsolete therapeutic advice item and the new therapeutic advice item.

On account of the rules, this knowledge base allows the respective doctor or therapist to prepare specific proposals for how to proceed further in the case of a therapy which is based on a therapeutic advice item which is now obsolete. The range of possible proposals extends from “Continue therapy on the basis of the obsolete therapeutic advice item” to “Change therapy to new therapeutic advice item immediately”.

This first takes into account the quality and scope of the changes in the therapeutic advice item, and secondly takes into account the duration of the therapy which has already been started. For this reason, provision is also advantageously made for each therapeutic information item to be assigned at least one date identifying the first use of the associated therapeutic advice item, and for the rule to be selected on the basis of the duration of the therapy in line with the obsolete therapeutic advice item. In the event of treatment which has just been started, it is useful to change over regardless of the type and scope of the changes in the therapeutic advice item. In the case of treatment which is just about to be concluded, provision is made for changing over to the new therapeutic advice item only in the rarest of cases.

An advantage of an embodiment of the invention and its refinements is, in particular, that the modern communication options can be used to tap medical knowledge and to make it available. The individual doctor or therapist always has access to current specialist medical knowledge which has already been prepared in the form of specific therapeutic advice items, in particular. Thus, even doctors and therapists who have a rather broader specialist orientation can apply therapies which were previously reserved for specialists in particular areas. This improves general healthcare. Healthcare is also improved by virtue of therapeutic advice items which have already been trialed at the start of treatment being available to the individual doctor or therapist. This and the associated decreased time involvement for the individual doctors and therapists also result in a considerable savings potential.

### BRIEF DESCRIPTION OF THE DRAWINGS

An exemplary illustrative non-limiting embodiment of the invention is explained in more detail below with reference to the drawings. Articles or elements which correspond to one another have been provided with the same reference symbols in all figures.

In the drawings:

FIG. 1 shows a first and a second database with data records which comprise therapeutic advice items and therapeutic information items,

FIG. 2 shows the activation of a new therapeutic advice item, and

FIG. 3 shows a knowledge base for automatic alignment of therapies with changed, complemented or updated therapeutic advice items.

### DETAILED DESCRIPTION OF THE PREFERRED EMBODIMENTS

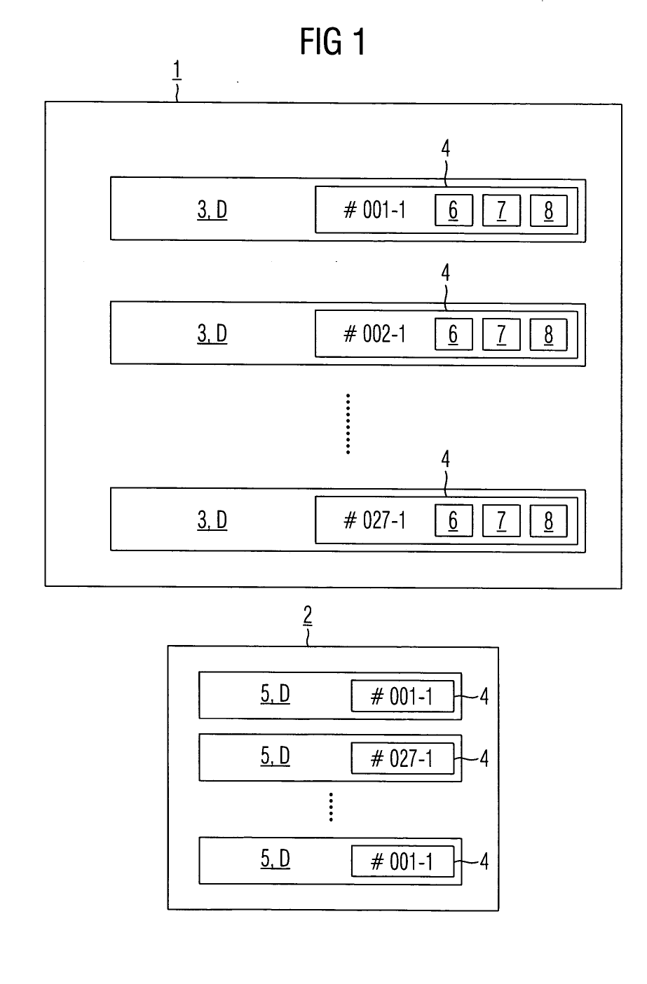

FIG. 1 shows a first database 1 and a second database 2. The first database 1 includes a number of data records D which include therapeutic advice items 3. These data records D are also referred to as data records D which include therapeutic advice items 3, or as therapeutic advice items 3 for short. Each therapeutic advice item 3 has a unique order feature 4. The content or the “value” of the order feature 4 is indicated in FIG. 1 to allow better distinguishability of reference symbols preceded by a “#” symbol. The order feature 4 of the first therapeutic advice item 3 stored in the first database 1 is, by way of example, “#001-1”, of the second is “#002-1”, and of the last is “#027-1”.

The second database 2 includes a number of data records D which include therapeutic information items 5. These data records D are also referred to as data records D which comprise therapeutic information items 5, or as therapeutic information items 5 for short.

The therapeutic information items 5 include, as data in the form of an electronic record, patient records, for example, but also, additionally, information items or data items relating to therapeutic and/or diagnostic means and resources. A therapeutic information item 5 has stored for it the order feature 4 of that therapeutic advice item 3 on which the therapy associated with the patient in question is based. Thus, the therapeutic information items 5 also relate, inter alia, to an individual, in particular person-related, therapy.

Accordingly, in line with the conditions illustrated, the first and last therapeutic information items 5, e.g. the first and last patient records, in the second database 2 are based on the first therapeutic advice item 3 in the first database 1, and the second therapeutic information item 5 in the second database 2 is based on the last therapeutic advice item 3 in the first database 1. Linking therapeutic information item 5 and therapeutic advice item 3 by means of the order feature 4 of the therapeutic advice item 3 ensures that therapeutic information item 5 and therapeutic advice item 3 are associated at all times. In other words: the therapeutic advice items 3 are, in particular, a medical guideline for treating a patient, inter alia. The therapeutic information items 5 are, in particular, a patient record, particularly an electronic patient record.

To identify whether a particular therapeutic advice item 3 has been released for use, the order feature 4 is assigned a release attribute 6. The release attribute 6 may relate to release of the therapeutic advice item 3 in question for general use or for use in a particular institution or in a particular region. For such purposes, the release attribute 6 is organized hierarchically.

To identify whether a particular therapeutic advice item 3, particularly a therapeutic advice item 3 which has been released for use, is intended to be used in a medical institution in the event of appropriate indications being present, the order feature 4 is additionally or alternatively assigned an activation attribute 7.

To identify whether a particular therapeutic advice item 3, particularly a therapeutic advice item 3 released for use, is actually being used, the order feature 4 is additionally or alternatively assigned a use attribute 8.

The use of individual therapeutic advice items 3 is explained in more detail below with reference to therapeutic information items 5.

In the first database 1, which is stored jointly for a large number of institutions in one medical institution or on a central server and is available via inherently known forms of electronic data networking, e.g. the Internet, (not shown) in the institution or institutions, each therapeutic advice item 3 has an associated unique order feature 4, e.g. a number, a keyword or an alphanumeric code. In the example, this is the code “001”, “002” and “027” for the therapeutic advice items 3 shown.

This order feature 4 also contains an information item relating to the version of the therapeutic advice item 3. Thus, two therapeutic advice items 3 which can be associated with the same medical problem or guideline but historically come after one another in terms of validity can be clearly identified as being associated. Further, the order feature 4 or its version information item also reveals the order in which the different therapeutic advice versions became effective. The version identifier is indicated by “−1” (for the first version) in the example.

It is particularly beneficial if the order feature 4, particularly the number, the keyword or the alphanumeric code, is formed in line with a generally binding standardized procedure. This makes every order feature 4 a unique order feature 4, i.e. each order feature 4 denotes precisely one therapeutic advice item 3.

The first database 1 or possibly even a further database uses an associated activation attribute 7 to store, for each order feature 4 of a therapeutic advice item 3, an information item about whether this therapeutic advice item 3 is obsolete or current and is thus used in the institution. In this context, “used in the institution” means that patients with the corresponding clinical picture in the institution are preferably treated in line with the recommendations of this therapeutic advice item 3, provided that there are no other conflicting case-specific medical concerns. The entry of a date on which the therapeutic advice item 3 became effective may partially perform the function of the activation attribute 7.

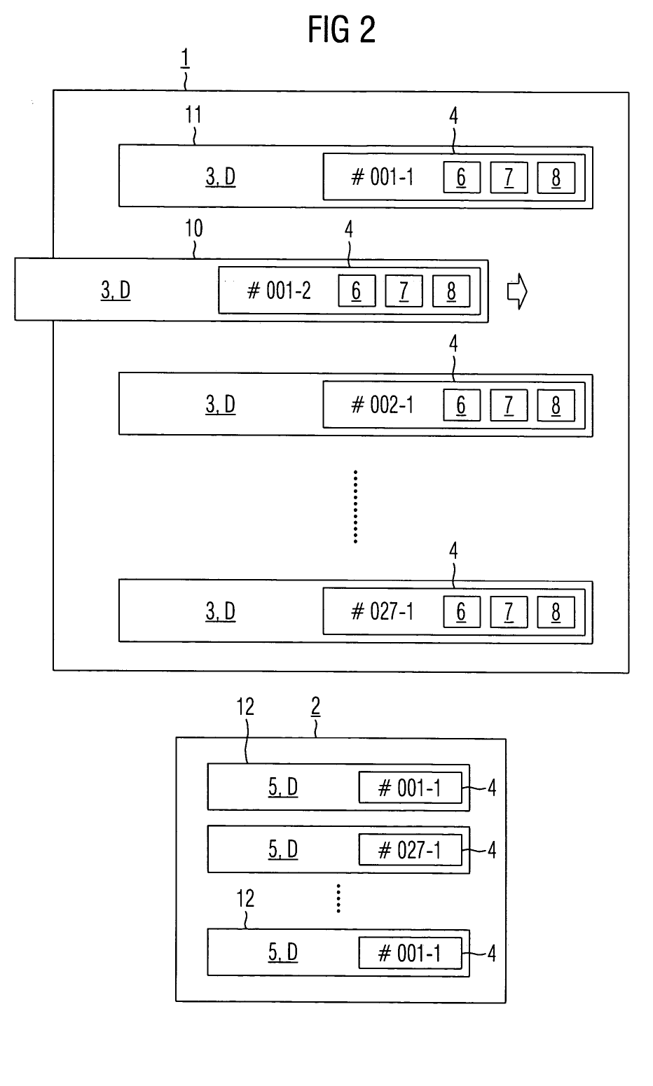

The storage location of the activation attribute 7 and also of the use attribute 8, whose significance will be described in more detail below, is basically arbitrary. It is advantageous to store these attributes together with the respective therapeutic advice item 3 (as illustrated in FIG. 1 and FIG. 2) when only a few or single institutions access the first database 1 or when the operator of the first database 1 is able to provide hierarchically organized forms of these attributes—activation attribute 7 and/or use attribute 8, so that a multiplicity of users also have access in distinguishable form.

If these attributes—activation attribute 7 and/or use attribute 8—are not stored in the first database 1, it is appropriate to store them in the second database 2. In that case, the second database 2 is broken down into two data areas, so to speak, namely into a data area containing therapeutic information items 5, which are linked to the underlying therapeutic advice item 3 by way of the order feature 4, and into a further data area containing attributes, that is to say the release, activation and/or use attribute 6, 7 and/or 8, which are linked to the underlying therapeutic advice item 3 likewise via the order feature 4.

When the two data areas in the second database 2 in the embodiment outlined above are independent of one another and the order feature 4 always provides an association with the respectively underlying therapeutic advice item 3, the data area with the attributes—release attribute 6, activation attribute 7 and/or use attribute 8—can also be provided in a separate further database (not shown). Such a separate database may be managed jointly for a group of institutions. A hierarchical plane which is “inserted”, so to speak, arises which is useful when a plurality of institutions access the first database 1 jointly but joint storage and management of all attributes in the first database 1 is not feasible or is feasible only with difficulty.

At the start of a medical therapy (diagnostic process, therapy, rehabilitation measure, etc.) carried out in line with a particular therapeutic advice item 3, the order feature 4 of this therapeutic advice item 3 and the date of the start of the therapy are stored in the second database 2, e.g. in the electronic patient record. Optionally or additionally, it may also be possible to store the foreseen duration or the foreseen end of the therapy. As an alternative to the date of the start of the therapy or else in addition, the use attribute 8 may be set to a prescribed value, for example, in the first database 1, so that this indicates that the therapeutic advice item 3 with this order feature 4 is currently being used in an active treatment process for at least one patient. When the therapy in line with the therapeutic advice item 3 ends, an end date is entered and/or the use attribute 8 is reset.

The text below uses FIG. 2 to give a more detailed explanation of the activation of a new therapeutic advice item 10, that is to say of a therapeutic advice item 3, which replaces an existing therapeutic advice item 3 (=obsolete therapeutic advice item 11).

The new therapeutic advice item 10 is transferred to the first database 1 together with a unique order feature 4—that is to say “#001-2”. In the example illustrated, the order feature 4 of the new therapeutic advice item 10 differs from the corresponding order feature 4 of the old therapeutic advice item 11 only in the changed version identifier (“−2”).

As soon as the activation attribute 7 of the new therapeutic advice item 10 is set to “activated”, the activation attribute 7 of the old therapeutic advice item 11 is automatically set to “deactivated”.

The or each second database 2 is searched for therapeutic information items 5 with the order feature 4 of the obsolete therapeutic advice item 11—that is to say “#001-1”. If a therapeutic information item 5 with the order feature 4 of the obsolete therapeutic advice item 11 is found in the or a second database 2, the use attribute 8 of the obsolete therapeutic advice item 11 is reset, by way of example, to a first value (“used”) in the first database 1. If a therapeutic information item 5 with the order feature 4 of the obsolete therapeutic advice item 11 is not found in the or a second database 2, the use attribute 8 of the obsolete therapeutic advice item 11 is reset to a second value (“deleted”). The entry of a date on which the validity of the therapeutic advice item 3 in or for the institution was canceled may partially replace the function of the activation attribute 7.

For all therapeutic information items 5 found which have the order feature 4 of the obsolete therapeutic advice item 11, a report is produced, e.g. an electronic mail to the treating doctor or therapist or the like. This ensures real-time direct information about changes in therapeutic advice items 3 which are incorporated into applied therapies.

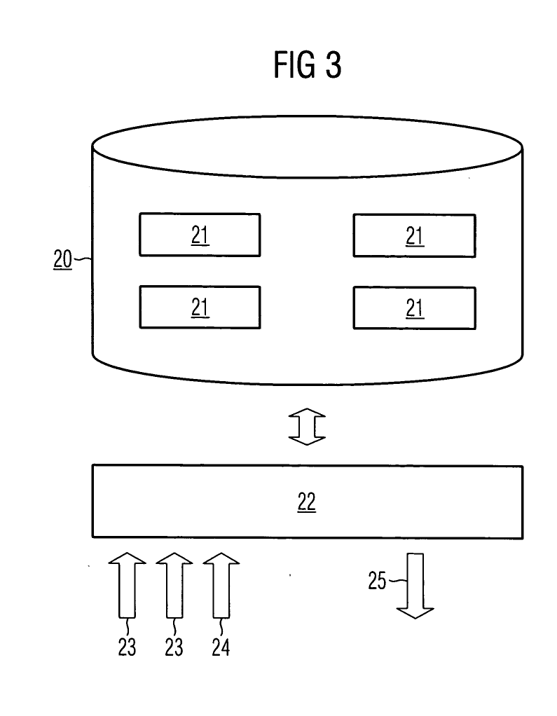

FIG. 3 shows a knowledge base 20 for automatic alignment of therapies with changed, complemented or updated therapeutic advice items 3. The knowledge base 20 stores a number of rules 21. Each rule 21 refers to advice items relating to a change from an obsolete therapeutic advice item 11 (FIG. 2) to a new therapeutic advice item 10 (FIG. 2). A selection algorithm 22 is used to select one of the rules 21 on the basis of the obsolete therapeutic advice item 11 and the new therapeutic advice item 10 and possibly on the basis of therapeutic information items 5. The new and the obsolete therapeutic advice item 10 and 11 and/or therapeutic information items 5 such as associated patient data items, e.g. the date of first use, are supplied to the selection algorithm 22 at inputs 23 which are provided for this purpose.

Advantageously, the selection of a rule 21 also includes the start, duration and/or total duration of a therapy. These data are available in the second database 2, e.g. as part of the therapeutic information item 5, 12. The data items are supplied to the selection algorithm 22 at a further input 24 which is provided for this purpose. The selection algorithm 22 then selects from the knowledge base 20 a rule 21 for changing from the obsolete therapeutic advice item 11 to the new therapeutic advice item 10 for a therapeutic information item 5, e.g. for a patient. An output 25 outputs instructions relating to the change from the obsolete therapeutic advice item 11 to the new therapeutic advice item 10 in line with the selected rule 21.

An embodiment of the invention specifies a method for referencing data records D which include therapeutic advice items 3, in which each data record D associated with a therapeutic advice item 3 is assigned a unique order feature 4 which is likewise stored together with a therapeutic information item 5, which is assigned to the therapeutic advice item 3, and where a therapeutic advice item 3 being updated prompts all of the therapeutic information items 5 to be searched for the order feature 4 of the updated therapeutic advice item 3 or 10, with a report which indicates the change in the underlying therapeutic advice item 3 or 10 being output for each therapeutic information item 5 found in the process.

Any of the aforementioned methods may be embodied in the form of a program. The program may be stored on a computer readable media and is adapted to perform any one of the aforementioned methods when run on a computer. Thus, the storage medium or computer readable medium, is adapted to store information and is adapted to interact with a data processing facility or computer to perform the method of any of the above mentioned embodiments.

The storage medium may be a built-in medium installed inside a computer main body or removable medium arranged so that it can be separated from the computer main body. Examples of the built-in medium include, but are not limited to, rewriteable involatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable involatile memory, such as memory cards; and media with a built-in ROM, such as ROM cassettes.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method involving a data record including therapeutic advice items, wherein a first database includes a number of data records for therapeutic advice items, the method comprising:
assigning each data record, associated with a therapeutic advice item, a unique order feature, wherein the order feature is assigned a version identifier.

2. The method as claimed in claim 1, wherein the order feature is at least one of assigned a release attribute indicating the release of the therapeutic advice item and assigned an activation attribute indicating the usability of the therapeutic advice item.

3. The method as claimed in claim 1, wherein the order feature is assigned a use attribute indicating the current use of the therapeutic advice item.

4. The method as claimed in claim 3, wherein at least one of the use attribute and the activation attribute includes a date.

5. The method as claimed in claim 1, wherein an underlying therapeutic advice item is identified in the second database at the start of a medical therapy and said therapeutic advice item's associated order feature and the date on which the therapy started are stored.

6. A method involving a data record including at least one therapeutic advice item, wherein a first database includes a plurality of data records, the method comprising:
assigning each data record, associated with a therapeutic advice item, a unique order feature; and
storing, in a second database including a plurality of data records for therapeutic information items relating to an individual therapy, for each data record associated with a therapeutic information item, if appropriate, the order feature of the therapeutic advice item on which the therapy is based.

7. The method as claimed in claim 6, wherein at least one of a change and update for a therapeutic advice item prompts the at least one of changed and updated therapeutic advice item to be stored, as a new therapeutic advice item in the form of a data record, in the first database together with a unique order feature, wherein the second database is searched for therapeutic information items having the order feature of the corresponding old therapeutic advice item on which the new therapeutic advice item is based, and wherein a report is generated for each obsolete order feature found in the second database.

8. The method as claimed in claim 6, wherein an appropriate report is generated for each therapeutic advice item newly stored in the first database.

9. The method as claimed in claim 6, wherein at least one of the first database and a further third database, at least one of assigns each therapeutic advice item and activates at least one of an activation attribute, indicating the usability of this therapeutic advice item, and a release attribute indicating the release of this therapeutic advice item.

10. The method as claimed in claim 6, wherein at least one of the first database and a further third database, at least one of assigns each therapeutic advice item and activates a use attribute, indicating the use of this therapeutic advice item.

11. The method as claimed in claim 10, wherein the at least one of the use attribute, the release attribute and the activation attribute includes a date.

12. The method as claimed in claim 10, wherein the use attribute is set if therapeutic information items based on the obsolete therapeutic advice item, are still identified in the second database.

13. The method as claimed in claim 6, wherein the order feature is assigned a descriptor for the therapeutic advice item and a version number.

14. The method as claimed in claim 6, wherein a knowledge base includes a plurality of stored rules , wherein each rule refers to advice items relating to a transition from an obsolete therapeutic advice item to a new therapeutic advice item, and wherein a selection algorithm is used to select one of the rules on the basis of the obsolete therapeutic advice item and the new therapeutic advice item and also on the basis of therapeutic information items.

15. The method as claimed in claim 14, wherein each therapeutic information item is assigned at least one date which characterizes the first use of the associated therapeutic advice item and where the rule is selected on the basis of the duration of the therapy in line with the obsolete therapeutic advice item.

16. The method as claimed in claim 1, wherein the therapeutic advice item represents a medical guideline, and wherein the therapeutic information item represents at least one of a patient record and information items relating to at least one of a therapeutic and diagnostic device.

17. The method as claimed in claim 1, wherein the order feature is assigned a use advice item.

18. A method for referencing a data record including at least one therapeutic advice item, wherein a first database includes a plurality of data records, the method comprising:
assigning each data record, associated with a therapeutic advice item, a unique order feature; and
assigning the order feature a version identifier.

19. The method as claimed in claim 18, wherein the order feature is further assigned a use advice item.

20. The method as claimed in claim 18, wherein the order feature is at least one of assigned a release attribute indicating the release of the therapeutic advice item and assigned an activation attribute indicating the usability of the therapeutic advice item.

21. The method as claimed in claim 18, wherein the order feature is assigned a use attribute indicating the current use of the therapeutic advice item.

22. The method as claimed in claim 21, wherein at least one of the use attribute and the activation attribute includes a date.

23. The method as claimed in claim 18, wherein an underlying therapeutic advice item is identified in the second database at the start of a medical therapy and said therapeutic advice item's associated order feature and the date on which the therapy started are stored.

24. The method as claimed in claim 1, wherein the data record is referenced according to the assigned order feature.

25. The method as claimed in claim 18, wherein the data record is referenced according to the assigned order feature.

26. The method as claimed in claim 6, wherein the data record is referenced according to the assigned order feature.

27. The method as claimed in claim 7, wherein an appropriate report is generated for each therapeutic advice item newly stored in the first database.

28. The method as claimed in claim 11, wherein the use attribute is set if therapeutic information items based on the obsolete therapeutic advice item, are still identified in the second database.

29. A device involving a data record including at least one therapeutic advice item, wherein a first database includes a plurality of data records, the device comprising:
means for assigning each data record, associated with a therapeutic advice item, a unique order feature; and
means for storing, in a second database including a plurality of data records for therapeutic information items relating to an individual therapy, for each data record associated with a therapeutic information item, if appropriate, the order feature of the therapeutic advice item on which the therapy is based.

30. A device for referencing a data record including at least one therapeutic advice item, wherein a first database includes a plurality of data records, the device comprising:
means for assigning each data record, associated with a therapeutic advice item, a unique order feature; and
means for assigning the order feature a version identifier.

31. A program, adapted to perform the method of claim 1, when executed on a computer.

32. A computer readable medium, storing the program of claim 31.

33. A program, adapted to perform the method of claim 6, when executed on a computer.

34. A computer readable medium, storing the program of claim 33.

35. A program, adapted to perform the method of claim 18, when executed on a computer.

36. A computer readable medium, storing the program of claim 35.
